(19) United States
(12) Patent Application Publication
(10) Pub. No.: US 2024/0359997 A1
(43) Pub. Date: Oct. 31, 2024

(54) LITHIUM METAL OXIDE NANOPARTICLES AND METHOD FOR PREPARING THEM

(71) Applicants: KOREA INSTITUTE OF ENERGY RESEARCH, Daejeon (KR); Center for Advanced Meta-Materials, Daejeon (KR)

(72) Inventors: Hyun Uk KIM, Daejeon (KR); Seong Ok HAN, Daejeon (KR); Tae Woo KIM, Daejeon (KR); Se Gi BYUN, Daejeon (KR); Jung Joon YOO, Daejeon (KR); IYAN SUBIYANTO, Daejeon (KR); Hak Joo LEE, Daejeon (KR)

(73) Assignees: KOREA INSTITUTE OF ENERGY RESEARCH, Daejeon (KR); Center for Advanced Meta-Materials, Daejeon (KR)

(21) Appl. No.: 18/140,949

(22) Filed: Apr. 28, 2023

(51) Int. Cl. C01G 23/00; B82Y 40/00

(52) U.S. Cl. CPC C01G 23/005; B82Y 40/00; C01P 2004/38; C01P 2006/12; C01P 2006/40

(57) ABSTRACT

The present invention relates to lithium metal oxide nanoparticles and a method for preparing the same and provides lithium metal oxide nanoparticles each having a shape of a hexahedron with a square outer cross section or a hexahedron with at least one chamfered corner and comprising a hollow of which a cross section is a square or a square having at least one chamfered corner, and a method for preparing the same, so that the lithium metal oxide nanoparticles can be utilized as an electrode material of a next-generation electronic device in which a contact area between an electrode and an electrolyte is increased to improve the charge and discharge rate characteristics and improve the conductivity.

### BACKGROUND OF THE INVENTION

### Field of the Invention

The present invention relates to lithium metal oxide nanoparticles and a method for preparing them and specifically to lithium metal oxide nanoparticles each having a shape of a hexahedron with a square outer cross section or a hexahedron with at least one chamfered corner and comprising a hollow of which a cross section is a square or a square having at least one chamfered corner, and a method for preparing the same.

### Description of the Related Art

Lithium-ion batteries are used in small home appliances such as smartphones and laptops as well as medium or large-sized energy storage devices for electric vehicles. In Japan and China, lithium-ion batteries are used for super-capacity energy storage systems in preparation for disasters and emergencies. In addition, since the Paris Climate Agreement held in 2015, more than 200 countries, comprising developing countries, have been obligated to reduce greenhouse gas emissions, and Germany (from 2030), the United Kingdom, and France (from 2040) have plans to prohibit new car sales of internal combustion locomotives, and thus increase of the global demand for electric vehicles is expected.

Spinel Li₄Ti₅O₁₂ (LTO) has a high operating voltage (1.55 to 1.56 V vs Li/Li+) and a very small volume change of 0.1% or less during intercalation and de-intercalation of lithium ions and thus is drawing attention as an anode or cathode material of a high-power lithium-ion battery that will stably produce high output. However, LTO has low ionic conductivity, and nano-sized LTO is separated onto the surface of the electrode to cause fouling of the separator or reaches the opposite electrode to cause a decrease in capacity, thereby occurring problems.

Therefore, it is necessary to provide a lithium metal oxide to solve this problem.

### SUMMARY OF THE INVENTION

One object of the present invention is to provide lithium metal oxide nanoparticles each having a shape of a hexahedron with a square outer cross section or a hexahedron with at least one chamfered corner and comprising a hollow of which a cross section is a square or a square having at least one chamfered corner.

Another object of the present invention is to provide a method for preparing the lithium metal oxide nanoparticles.

Another object of the present invention is to provide an electrode for an electronic device comprising the lithium metal oxide nanoparticles.

The technical problem to be achieved by the present invention is not limited to the technical problems described above, and other technical problems that are not described can be clearly understood by those skilled in the art from the description below.

One aspect of the present invention relates to lithium metal oxide nanoparticles.

The lithium metal oxide nanoparticles according to an aspect of the present invention each may have a shape of a hexahedron with a square outer cross section or a hexahedron with at least one chamfered corner and comprise a hollow of which a cross section is a square or a square having at least one chamfered corner.

In an embodiment of the present invention, a ratio (a/b) of the length (a) of a side of the outer cross section of the lithium metal oxide nanoparticle to a length (b) of one side of a square cross section of the hollow may be 1.2 to 10.

According to an embodiment of the present invention, a thickness of the lithium metal oxide on the hollow may be 5 to 200 nm.

According to an embodiment of the present invention, a BET surface area of the lithium metal oxide may be 20 to 200 m²/g.

According to an embodiment of the present invention, an outer diameter or a length of the longest side of the lithium metal oxide nanoparticles may be 15 to 1,000 nm.

According to an embodiment of the present invention, the lithium metal oxide may be lithium titanium oxide (LTO).

According to an embodiment of the present invention, the lithium metal oxide is synthesized from a calcium-containing intermediate having a shape of a hexahedron with a square outer cross section or a hexahedron with at least one chamfered corner and may comprise a hollow while the shape of the hexahedron or the hexahedron with at least one chamfered corner is maintained.

Another aspect of the present invention relates to a method for preparing lithium metal oxide nanoparticles.

The method for preparing lithium metal oxide nanoparticles according to another aspect of the present invention comprises preparing a titanium-containing intermediate having a shape of a hexahedron with a square outer cross section or a hexahedron with at least one chamfered corner; preparing a titanium oxide comprising a hollow by using the titanium-containing intermediate; mixing the titanium oxide with a lithium source in a solvent to obtain a dispersed composition; performing a heat treatment on the composition; and washing, drying, and calcining a reactant obtained after the heat treatment.

According to an embodiment of the present invention, the heat treatment on the composition may be performed for 5 to 20 hours at a temperature of 150° C. to 200° C.

According to an embodiment of the present invention, the calcining is performed for 60 to 180 minutes at a temperature of 800° C. to 1,000° C.

According to an embodiment of the present invention, in the mixing of the titanium oxide with the lithium source in the solvent to obtain the dispersed composition, a molar ratio (B/A) of the lithium source (B) to the titanium oxide (A) is 9 to 11.

According to an embodiment of the present invention, the preparing of the titanium-containing intermediate may comprise: mixing a calcium source, polyalkylene glycol, and a titanium source in a solvent to prepare a second dispersed composition; and performing a heat treatment on the second dispersed composition.

According to an embodiment of the present invention, the mixing may be performed at a molar ratio (D/C) of the calcium source (C) and the titanium source (D) of 1 to 3.

According to an embodiment of the present invention, the preparing of the titanium oxide comprising the hollow by using the titanium-containing intermediate may comprise: mixing the titanium-containing intermediate and a chelating agent in a solvent to prepare a third dispersed composition; performing a heat treatment on the third dispersed composition; washing a resultant obtained after the heat treatment with a solvent and drying; and calcining the dried resultant to obtain a titanium oxide.

According to an embodiment of the present invention, the mixing may be performed at a molar ratio (F/E) of the titanium-containing intermediate (E) and the chelating agent (F) of 1 to 3.

According to an embodiment of the present invention, the chelating agent may be one selected from the group consisting of ethylenediaminetetraacetic acid-disodium (EDTA-2Na), EDTA-3Na, EDTA-4Na, and EDTA-4H.

According to an embodiment of the present invention, the heat treatment on the third composition may be performed for 5 to 20 hours at a temperature of 150° C. to 200° C.

According to an embodiment of the present invention, the calcining of the dried resultant to obtain the titanium oxide may be performed for 60 to 180 minutes at a temperature of 300° C. to 500° C.

Another aspect of the present invention relates to an electrode for an electronic device comprising the lithium metal oxide nanoparticle.

According to an embodiment of the present invention, there are provided lithium metal oxide nanoparticles each having a shape of a hexahedron with a square outer cross section or a hexahedron with at least one chamfered corner and comprising a hollow of which a cross section is a square or a square having at least one chamfered corner, and a method for preparing the same, so that the lithium metal oxide nanoparticles can be utilized as an electrode material of a next-generation electronic device in which a contact area between an electrode and an electrolyte is increased to facilitate the diffusion of Li ions and thus improve the charge and discharge rate characteristics and to improve the conductivity, resulting in excellent output characteristics and stability.

The effects of the present invention are not limited to the above effects, and should be understood to comprise all effects that can be inferred from the description of the present invention or the configuration of the invention described in the claims.

### BRIEF DESCRIPTION OF THE DRAWINGS

The patent or application file contains at least one color drawing. Copies of this patent or patent application publication with color drawing will be provided by the USPTO upon request and payment of the necessary fee.

FIG. 1 is a scanning electron microscopy (SEM) image of a CaTiO₃ cube prepared according to Preparation Example 1 (30K magnification);

FIG. 2 illustrates a powder X-ray diffraction (PXRD) pattern of the CaTiO₃ cube prepared according to Preparation Example 1;

FIG. 3 is a scanning electron microscopy (SEM) image of a TiO₂ cube prepared according to Preparation Example 2 (50K magnification);

FIG. 4 illustrates a powder X-ray diffraction (PXRD) pattern of the TiO₂ cube prepared according to Preparation Example 2;

FIG. 5 dis a scanning electron microscopy (SEM) image of LTO nanocubes prepared according to Example 1 (50K magnification); and

FIG. 6 is a powder X-ray diffraction (PXRD) pattern of the LTO nanocubes prepared according to Example 1.

### DETAILED DESCRIPTION OF THE PREFERRED EMBODIMENTS

Terms used in the present invention are only used to describe specific examples and are not intended to limit the present invention. In the entire specification of the present invention, ‘comprising’ a certain component means that other elements may be further comprised, rather than excluding other elements unless otherwise stated.

Among physical properties mentioned in this specification, the physical properties in which the measured temperature and/or the measured pressure affect results are results measured at room temperature and/or normal pressure, unless otherwise stated.

The term ‘room temperature’ refers to a natural temperature that is not heated or cooled, and means, for example, any temperature within the range of 10° C. to 30° C., a temperature about 23° C. or about 25° C. In addition, the unit of temperature in this specification is 24° C. unless otherwise defined.

The term ‘normal pressure’ is a natural pressure that is not pressurized or reduced, and usually means about 1 atm of the atmospheric pressure level.

In the present specification, in the case of physical properties in which the measured humidity affects results are physical properties measured at natural humidity that is not particularly controlled at room temperature and/or normal pressure, unless otherwise defined.

A first aspect of the present invention relates to lithium metal oxide nanoparticles.

The lithium metal oxide nanoparticles according to the first aspect of the present invention each may have a shape of a hexahedron with a square outer cross section or a hexahedron with at least one chamfered corner and comprise a hollow of which a cross section is a square or a square having at least one chamfered corner.

In an embodiment of the present invention, a ratio (a/b) of the length (a) of a side of the outer cross section of the lithium metal oxide nanoparticle to a length (b) of one side of a square cross section of the hollow may be 1.2 to 10. In another example, the ratio (a/b) of the length of a side of the outer cross section of the lithium metal oxide nanoparticle (a) to the length of one side of the square cross section of the hollow (b) may be 1.3 or more, 1.4 or more, or 1.5 or more or may be 9 or less, 8 or less, 7 or less, 6 or less, 5 or less, 4 or less, or 3 or less.

According to the embodiment of the present invention, the thickness of the lithium metal oxide on the hollow may be 5 to 200 nm. In another example, the thickness of the lithium metal oxide on the hollow may be 10 nm or more, 40 nm or more, or 80 nm or more or may be 190 nm or less, 180 nm or less, or 150 nm or less.

According to the embodiment of the present invention, the BET surface area of the lithium metal oxide may be 20 to 200 m²/g. In another example, the BET surface area of the lithium metal oxide may be 25 m²/g or more, 30 m²/g or more, or 35 m²/g or more or may be 195 m²/g or less, 190 m²/g or less, 185 m²/g or less.

According to the embodiment of the present invention, the outer diameter or the length of the longest side of the lithium metal oxide nanoparticles may be 15 to 1,000 nm. In another example, the outer diameter or the length of the longest side of the lithium metal oxide nanoparticles may be 50 nm or more, 100 nm or more, 150 nm or more, 200 nm or more, 250 nm or more, 300 nm or more or may be 350 nm or more or may be 900 nm or less, 800 nm or less, 700 nm or less, 600 nm or less, or 500 nm or less.

According to the embodiment of the present invention, the lithium metal oxide may be lithium titanium oxide (LTO).

According to the embodiment of the present invention, the lithium metal oxide is synthesized from a calcium-containing intermediate having a shape of a hexahedron with a square outer cross section or a hexahedron with at least one chamfered corner and may comprise a hollow while the shape of the hexahedron or the hexahedron with at least one chamfered corner is maintained.

A second aspect of the present invention relates to a method for preparing lithium metal oxide nanoparticles.

Although detailed descriptions of portions overlapping with those of the first aspect of the present invention have been omitted, the description of the first aspect of the present invention can be equally applied even if the description is omitted from the second aspect, unless otherwise stated.

The method for preparing lithium metal oxide nanoparticles according to the second aspect of the present invention may comprise preparing a titanium-containing intermediate having a shape of a hexahedron with a square outer cross section or a hexahedron with at least one chamfered corner; preparing a titanium oxide comprising a hollow by using the titanium-containing intermediate; mixing the titanium oxide with a lithium source in a solvent to obtain a dispersed composition; performing a heat treatment on the composition; and washing, drying, and calcining a reactant obtained after the heat treatment.

According to the embodiment of the present invention, the solvent is not particularly limited, but, for example, one or more solvents selected from the group consisting of alkylene glycol, alcohol, water (H₂O), and combinations thereof maybe used, and preferably one or more solvents selected from ethylene glycol, ethanol, and ultrapure distilled water may be used.

According to the embodiment of the present invention, the lithium source may be one or more selected from Li₂CO₃, LiOH, LiNO₃, Li₂C₂O₄, Li₃PO₄, Li₂HPO₄, LiHCO₃, LiOOCCH₃, LiVO₃, and combinations thereof.

According to the embodiment of the present invention, the heat treatment on the composition may be performed, for example, in a temperature range of 150° C. to 200° C. In another example, the heat treatment on the composition may be performed at a temperature of 155° C. or more, 160° C. or more, or 165° C. or more and may be performed at a temperature of 195° C. or less, 190° C. or less, or 185° C. or less.

According to the embodiment of the present invention, the heat treatment on the composition may be performed for 5 to 20 hours. In another example, the heat treatment on the composition may be performed for 6 hours or more, 7 hours or more, or 8 hours or more or may be performed for 19 hours or less, 18 hours or less, or 17 hours or less.

According to the embodiment of the present invention, the washing after the heat treatment may be performed with alcohol, preferably with ethanol. In addition, the number of times of washing is not particularly limited and may be performed once or more, preferably twice or more.

According to the embodiment of the present invention, the calcining is performed in a temperature range of 800° C. to 1,000° C. In another example, the calcining may be performed at a temperature of 810° C. or more, 820° C. or more, or 830° C. or more and may be performed at a temperature of 990° C. or less, 980° C. or less, or 970° C. or less.

According to the embodiment of the present invention, the calcining may be performed for 60 to 180 minutes. In another example, the calcining may be performed for 70 minutes or more, 80 minutes or more, or 90 minutes or more or may be performed for 170 minutes or less, 160 minutes or less, or 150 minutes or less.

According to the embodiment of the present invention, the temperature increase rate in the calcining may be appropriately selected without limitation in relation to the heat treatment time and preferably may be 2° C./min.

By limiting the temperature and time within the above ranges, a crystallization effect may be exhibited.

According to the embodiment of the present invention, the calcining may be performed in a vacuum state. In addition, according to the embodiment of the present application, the heat treatment may be performed in the presence of oxygen. This is only an example of conditions without limitations that can be selected for the efficient heat treatment but is not limited thereto.

According to the embodiment of the present invention, in the mixing of the titanium oxide with the lithium source in the solvent to obtain the dispersed composition, a molar ratio (B/A) of the lithium source (B) to the titanium oxide (A) may be 9 to 11. In another example, the molar ratio (B/A) of the lithium source (B) to the titanium oxide (A) may be 9.1 or more, 9.2 or more, or 9.3 or more or may be 10.9 or less, 10.8 or less, or 10.7 or less.

The crystalline phase may be controlled by limiting the amounts of the titanium oxide (A) and the lithium source (B) within the ranges described above.

According to the embodiment of the present invention, the preparing of the titanium-containing intermediate may comprise: mixing a calcium source, polyalkylene glycol, and a titanium source in a solvent to prepare a second dispersed composition; and performing a heat treatment on the second dispersed composition.

According to the embodiment of the present invention, the calcium source is a calcium-containing ionic inorganic compound and may be one or more selected from the group consisting of calcium chloride, calcium hydroxide, calcium sulfide, calcium nitrate, calcium fluoride, and combinations thereof and preferably may be calcium chloride or calcium hydroxide.

According to the embodiment of the present invention, the polyalkylene glycol is that having a molecular weight of 10,000 g/mol or less and is not particularly limited, but may be, for example, one or more selected from the group consisting of polyethylene glycol, polypropylene glycol, polybutylene glycol, and combinations thereof. More preferably, it may be PEG (polyethylene glycol)-200, PEG-400, PEG-600, PEG-1000, PEG-1500, PEG-4000, PEG-6000, or PEG-8000.

According to the embodiment of the present invention, with respect to the titanium source, a metal precursor may be, for example, a material containing a tetravalent titanium cation and may comprise one containing an anion selected from the group consisting of an alkoxide group, carbonate, halide, amidinate, diketonate, and combinations thereof. Preferably, it may be titanium(IV) isopropoxide or titanium(IV) n-butoxide.

According to the embodiment of the present invention, the solvent is not particularly limited, but, for example, one or more solvents selected from the group consisting of alkylene glycol, alcohol, sodium hydroxide, water (H₂O), and combinations thereof may be used. Preferably, the solvent may be selected the group consisting of ethylene glycol, ethanol, sodium hydroxide, ultrapure distilled water, and combinations of one or more thereof.

According to the embodiment of the present invention, in the mixing, a molar ratio (D/C) of the calcium source (C) and the titanium source (D) may be 1 to 3. In another example, the molar ratio (D/C) of the calcium source (C) and the titanium source (D) may be 1.1 or more, 1.2 or more, or 1.3 or more or may be 2.9 or less, 2.8 or less, or 2.7 or less. The crystalline phase may be controlled by limiting the amounts of the calcium source (C) and the titanium source (D) within the ranges described above.

According to the embodiment of the present invention, the heat treatment on the second dispersed composition may be performed in a temperature range of 150° C. to 200° C. In another example, the heat treatment on the second dispersed composition may be performed at a temperature of 155° C. or more, 160° C. or more, or 165° C. or more or may be performed at a temperature of 195° C. or less, 190° C. or less, or 185° C. or less.

According to the embodiment of the present invention, the heat treatment on the second dispersed composition may be performed for 5 to 20 hours. In another example, the heat treatment on the second dispersed composition may be performed for 6 hours or more, 7 hours or more, or 8 hours or more or may be performed for 19 hours or less, 18 hours or less, or 17 hours or less.

By limiting the temperature and time within the above ranges, a crystallization effect may be exhibited.

According to the embodiment of the present invention, the resultant after the heat treatment on the second dispersed composition may be washed with water and (or) alcohol. Preferably, it may be washed with water or (and) ethanol. The number of times of the washing is not particularly limited and may be one or more, preferably is two or more.

According to the embodiment of the present invention, the resultant after the heat treatment of the second dispersed composition may be dried, for example, at 50° C. to 90° C. In another example, the resultant after the heat treatment of the second dispersed composition may be dried at 55° C. or more, 60° C. or more, or 65° C. or more or may be dried at 85° C. or less, 80° C. or less, or 75° C. or less.

According to the embodiment of the present invention, the preparing of the titanium oxide comprising the hollow by using the titanium-containing intermediate may comprise: mixing the titanium-containing intermediate and a chelating agent in a solvent to prepare a third dispersed composition; performing a heat treatment on the third dispersed composition; washing a resultant obtained after the heat treatment with a solvent and drying; and calcining the dried resultant to obtain a titanium oxide.

According to the embodiment of the present invention, in the mixing, a molar ratio (F/E) of the titanium-containing intermediate (E) and the chelating agent (F) may be 1 to 3. In another example, the molar ratio (F/E) of the titanium-containing intermediate (E) and the chelating agent (F) may be 1.1 or more, 1.2 or more, or 1.3 or more or may be 2.9 or less, 2.8 or less, or 2.7 or less. The crystalline phase may be controlled by limiting the amounts of the titanium-containing intermediate (E) and the chelating agent (F) within the ranges described above.

According to the embodiment of the present invention, the chelating agent may be one selected from the group consisting of ethylenediaminetetraacetic acid-disodium (EDTA-2Na), EDTA-3Na, EDTA-4Na, and EDTA-4H.

According to the embodiment of the present invention, the heat treatment on the third dispersed composition may be performed in a temperature range of 150° C. to 200° C. In another example, the heat treatment on the third composition may be performed at a temperature of 155° C. or more, 160° C. or more, or 165° C. or more and may be performed at a temperature of 195° C. or less, 190° C. or less, or 185° C. or less.

According to the embodiment of the present invention, the heat treatment on the third composition may be performed for 5 to 20 hours. In another example, the heat treatment on the third composition may be performed for 6 hours or more, 7 hours or more, or 8 hours or more or may be performed for 19 hours or less, 18 hours or less, or 17 hours or less.

By limiting the temperature and time within the above ranges, a crystallization effect may be exhibited.

According to the embodiment of the present invention, the resultant after the heat treatment of the third dispersed composition may be washed with water and (or) alcohol. Preferably it may be washed with water or (and) ethanol. The number of times of the washing is not particularly limited and may be one or more, preferably is two or more.

According to the embodiment of the present invention, the resultant after the heat treatment of the third dispersed composition may be dried, for example, at 50° C. to 90° C. In another example, the resultant after the heat treatment of the third dispersed composition may be dried at 55° C. or more, 60° C. or more, or 65° C. or more or may be dried at 85° C. or less, 80° C. or less, or 75° C. or less.

According to the embodiment of the present invention, the calcining of the dried resultant to obtain the titanium oxide may be performed in a temperature range of 300° C. to 500° C. In another example, the calcining of the dried resultant to obtain the titanium oxide may be performed at a temperature of 310° C. or more, 320° C. or more, or 330° C. or more or may be performed at a temperature of 490° C. or less, 480° C. or less, or 470° C. or less.

According to the embodiment of the present invention, the calcining of the dried resultant to obtain the titanium oxide may be performed for 60 to 180 minutes. In another example, the calcining of the dried resultant to obtain the titanium oxide may be performed for 65 minutes or more, 70 minutes or more, or 75 minutes or more calcine, and may be performed for 175 minutes or less, 170 minutes or less, or 165 minutes or less calcine.

By limiting the temperature and time within the above ranges, a crystallization effect may be exhibited.

According to the embodiment of the present invention, the temperature increase rate in the calcining of the dried resultant to obtain the titanium oxide may be appropriately selected without limitation in relation to the heat treatment time and preferably may be 2° C./min.

According to the embodiment of the present application, the calcining of the dried resultant to obtain the titanium oxide may be performed in a vacuum state. In addition, according to the embodiment of the present application, the heat treatment may be performed in the presence of oxygen. This is only an example of conditions without limitations that can be selected for the efficient heat treatment but is not limited thereto.

A third aspect of the present invention relates to an electrode for an electronic device comprising the lithium metal oxide nanoparticle.

Although detailed descriptions of portions overlapping with those of the first and second aspects of the present invention have been omitted, the description of the first and second aspects of the present invention can be equally applied even if the description is omitted from the third aspect, unless otherwise stated.

According to the embodiment of the present invention, the electrode may be used for a secondary battery or a supercapacitor, and as an electrode active material, the lithium metal oxide nanoparticle has a shape of a hexahedron with a square outer cross section or a hexahedron with at least one chamfered corner and comprises a hollow of which the cross section is a square or a square having at least one chamfered corner, and thus increases the the charge and discharge rate and the conductivity. Specifically, the ratio (a/b) of the length (a) of the side of the outer cross section of the lithium metal oxide nanoparticle to the length (b) of one side of the square cross section of the hollow may be 1.2 to 10, and the thickness of the lithium metal oxide on the hollow may be 5 to 200 nm. In addition, the BET surface area of the lithium metal oxide may be 20 to 200 m²/g, and the outer diameter or the length of the longest side of the lithium metal oxide nanoparticles may be 15 to 1,000 nm.

According to the embodiment of the present invention, the electrode active material may be formed on an electrode current collector. In this case, the type of the electrode current collector may not be significantly limited as long as the electrode current collector has conductivity without causing a chemical change of the device. For example, the electrode current collector may comprise stainless steel, aluminum, nickel, titanium, calcined carbon, or a material in which carbon, nickel, titanium, silver, or the like is surface-treated on the surface of aluminum or stainless steel. Meanwhile, the electrode current collector may have a thickness of about 3 μm to 500 μm, and fine irregularities may be formed on the surface of the current collector to increase the adhesion of the electrode active material. That is, the electrode current collector may be usable in various forms such as films, sheets, foils, nets, porous bodies, foams, and non-woven fabrics.

According to the embodiment of the present invention, the electrode active material may further comprise a conductive material and a binder in addition to the active material. In this case, the conductive material is used to impart conductivity to the electrode, and the type of the conductive material may not be significantly limited as long as the material has electrical conductivity without causing a chemical change of the device. For example, the conductive material may comprise a material selected from the group consisting of graphite such as natural graphite or artificial graphite, carbon black, acetylene black, Ketjenblack, channel black, furnace black, lamp black, thermal black, metal powder or metal fibers such as carbon-based materials such as carbon fiber, copper, nickel, aluminum, or silver, conductive whiskey such as zinc oxide and potassium titanate, conductive metal oxides such as titanium oxide, conductive polymers such as polyphenylene derivatives, and combinations thereof. Meanwhile, the conductive material may be generally used in the content of 1 to 30 parts by weight based on 100 parts by weight of the electrode active material.

In addition, the binder may serve to improve the adhesion between particles of the electrode active material and the adhesive strength between the electrode active material and the current collector. Specifically, the binder may comprise, for example, a material selected from the group consisting of polyvinylidene fluoride (PVDF), a vinylidene fluoride-hexafluoropropylene copolymer (PVDF-co-HFP), polyvinyl alcohol, polyacrylonitrile, carboxymethylcellulose (CMC), starch, hydroxypropylcellulose, regenerated cellulose, polyvinylpyrrolidone, tetrafluoroethylene, polyethylene, polypropylene, ethylene-propylene-diene polymer (EPDM), sulfonated-EPDM, styrene butadiene rubber (SBR), fluororubber, various copolymers thereof, and combinations thereof. Meanwhile, the binder may be generally used in the content of 1 to 30 parts by weight based on 100 parts by weight of the electrode active material.

In addition, the supercapacitor may preferably be a hybrid supercapacitor, and the hybrid supercapacitor may specifically comprise: an anode; a cathode; and a separator and an electrolyte interposed between the anode and the cathode. In this case, the electrode active material is preferably used as an active material of the cathode, and activated carbon may be used as an anode active material of the anode.

According to the embodiment of the present invention, the electrolyte used in the hybrid supercapacitor may be a mixture of a salt and an additive in an organic solvent. At this time, the organic solvent may be a material selected from the group consisting of acetonitrile (ACN), ethylene carbonate (EC), propylene carbonate (PC), dimethyl carbonate (DMC), diethyl carbonate (DEC), ethylmethyl carbonate (EMC), 1,2-dimethoxyethane (DME), γ-butrolactone (GBL), methyl formate (MF), methyl propionate (MP), and combinations thereof. In addition, the salt is used in an amount of 0.8 to 2 M and may be a mixture of a lithium (Li) salt and a non-lithium salt. The lithium (Li) salt accompanies intercalation/de-intercalation reactions into the structure of the cathode electrode active material, that is, the metal-organic framework, and the types thereof may comprise a material selected from the group consisting of LiBF₄, LiPF₆, LiClO₄, LiAsF₆, LiAlCl₄, LiCF₃SO₃, LiN(SO₂CF₃)₂, LiC(SO₂CF₃)₃, lithium bis(oxalato)borate (LiBOB), and combinations thereof. In addition, the non-lithium salt accompanies an adsorption/desorption reaction on the surface area of the carbon material additive and may be used in the mixture of 0 to 0.5 M with the lithium salt. In this case, the non-lithium salt may comprise a material selected from the group consisting of tetraethylammonium tetrafluoroborate (TEABF₄), Triethylmethylammonium tetrafluoroborate (TEMABF₄), spiro-(1,1′)-bipyrrolidium tetrafluoroborate (SBPBF₄), and combinations thereof. In addition, the carbon material additive may comprise a material selected from the group consisting of vinyl carbonate (VC), vinyl ethylene carbonate (VEC), fluoroethylene carbonate (FEC), and combinations thereof.

According to the embodiment of the present invention, the separator is positioned between the anode and the cathode to prevent the anode and the cathode from being physically in contact with each other and electrically shorted, and a porous material may be used. For example, the separator may comprise a material selected from the group consisting of polypropylene-based, polyethylene-based, polyolefin-based materials, and combinations thereof.

According to the embodiment of the present invention, the hybrid supercapacitor having the above configuration uses crystalline lithium-metal oxide particles as the electrode active material, and thus has the improved capacity owing to a high specific surface area to exhibit high energy density and output characteristics. That is, the crystalline lithium-metal oxide particle has a homogeneous pore size and particle size, and thus a hybrid supercapacitor comprising the crystalline lithium-metal oxide particle may exhibit excellent capacitance and output characteristics.

### Preparation Example 1. Preparation of CaTiO₃ Cube

110 mg (0.75 mmol) of CaCl₂)·H₂O was dissolved in a mixture of 1.00 ml of polyethylene glycol (PEG-200, Mw: 200) and 19.00 ml of ethanol. Then, 0.33 ml (1.09 mmol) of titanium(IV) isopropoxide and 240 mg (6.00 mmol) of sodium hydroxide (NaOH) were added to the mixture. Thereafter, after being sufficiently stirred to make a homogeneous mixed solution, the mixture was heated at 180° C. for 15 hours in a Teflon-lined stainless-steel autoclave. The obtained sample was filtered, then washed three times each with water (H₂O) and ethanol, and dried at 70° C.

### Preparation Example 2. Synthesis of TiO₂ Cube

75 mg (0.55 mmol) of CaTiO₃ obtained in Preparation Example 1 and 340 mg (1.01 mmol) of disodium ethylenediaminetetraacetate (EDTA-2Na) were dispersed in a mixed solution of 10.00 ml of ethylene glycol and 30 ml of ultrapure distilled water (DI water). After being stirred for 30 minutes, the mixture was heated in a 40 ml of Teflon-lined stainless-steel autoclave at 180° C. for 12 hours. The obtained sample was sufficiently washed with water (H₂O) and ethanol and dried at 70° C. The obtained powder was then calcined for 2 hours (2° C./min rate) at 400° C. in atmosphere.

### Example 1. Synthesis of LTO Nanocube

100 mg (1.25 mmol) of hollow TiO₂ cubes obtained in Preparation Example 2 were reacted with 530 mg (12.63 mmol) of LiOH·H₂O in a mixed solution of 18 ml of ultrapure distilled water (DI water) and 18 ml of ethanol. Thereafter, the mixture was sufficiently stirred for 30 minutes or more to be uniformly dispersed in a white color and then heated at 180° C. for 12 hours in a Teflon-lined stainless-steel autoclave (40 ml). After being naturally cooled at room temperature, the obtained LTO nanoparticles were filtered, washed three times only with ethanol, and dried at room temperature. Finally, the LTO nanoparticles were calcined in atmosphere at 900° C. for 2 hours (2° C./min rate).

### Experimental Example 1. Surface, Structure, and Shape Analysis

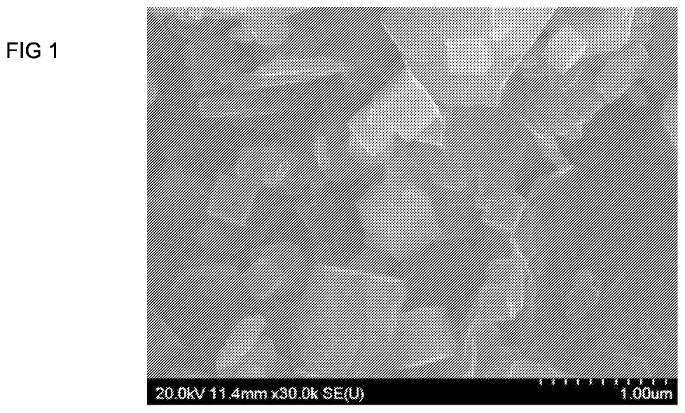

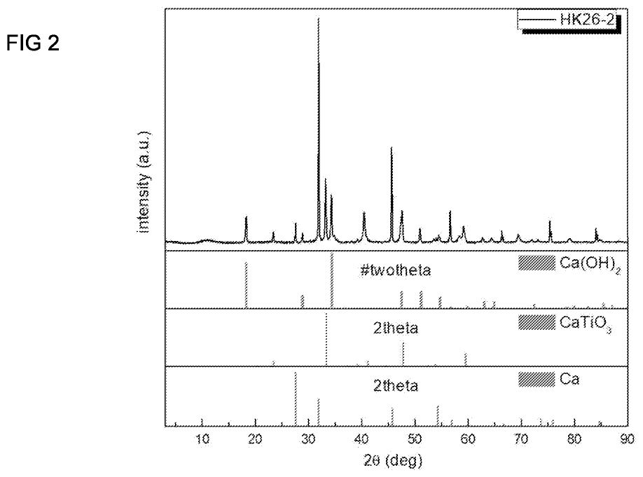

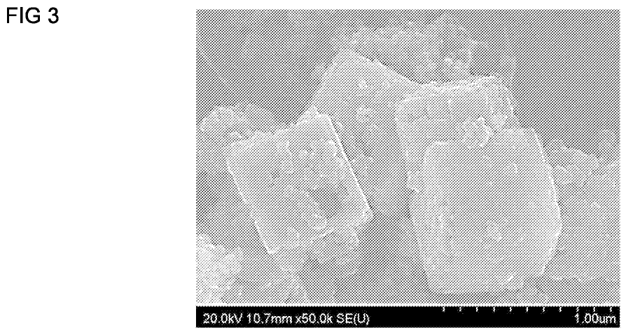

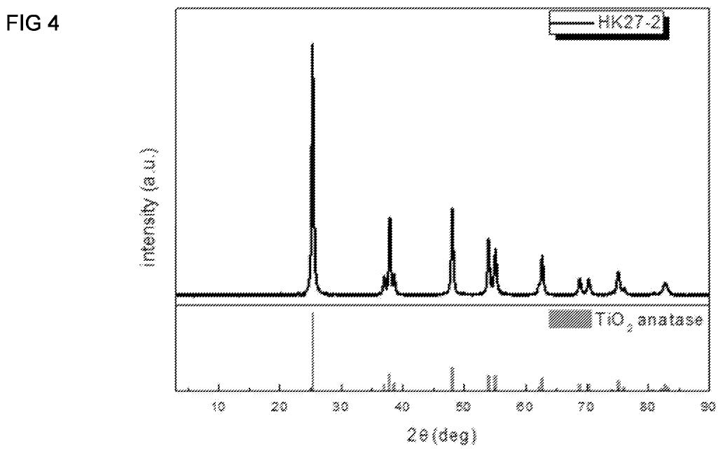

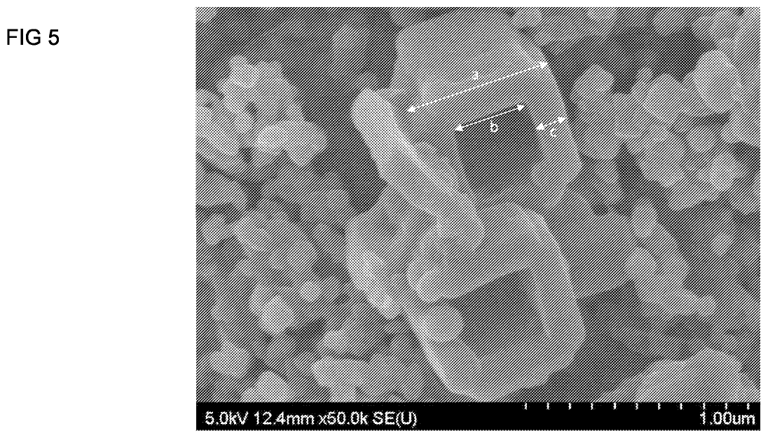

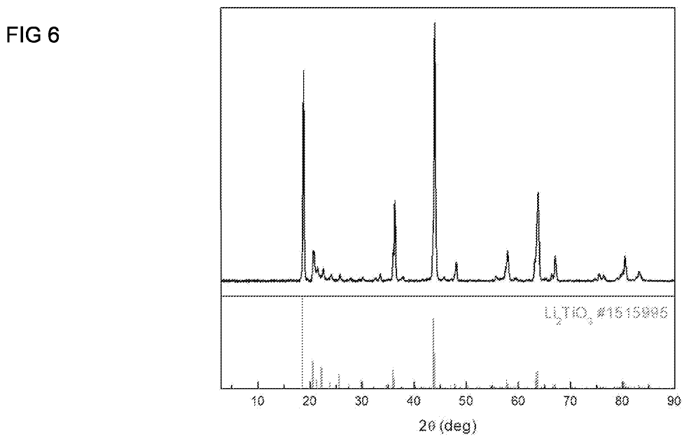

CaTiO₃/Ca(OH)₂/Ca cubes, TiO₂ cubes, and LTO nanocubes prepared according to Preparation Example 1, Preparation Example 2, and Example 1 were powdered to prepare specimens and were analyzed by using scanning electron microscopy (SEM; S-4800, HITACHI) and powder X-ray diffraction (PXRD; MiniFlex 600, RIGAKU), and as a result, it was confirmed that CaTiO₃/Ca(OH)₂/Ca synthesized according to Preparation Example 1 had a nanometer-sized cube shape and that CaTiO₃/Ca(OH)₂/Ca phases were mixed (FIGS. 1 and 2). It was also confirmed that TiO₂ synthesized according to Preparation Example 2 had a cube form of anatase (FIGS. 3 and 4), that the LTO nanocube synthesized according to Example 1 had a hollow tube form and that Li₄Ti₅O₁₂ and rutile TiO₂ were mixed (FIGS. 5 and 6). In addition, it was possible to confirm that, in the lithium metal oxide nanoparticle synthesized according to Example 1, the length of a side of the square cross section of the hollow (b in FIG. 5) was 200 nm, the length of a side of the outer cross section (a in FIG. 5) was 400 nm, and the thickness of lithium metal oxide on the hollow (c of FIG. 5) was 100 nm.

The above description of the present invention is for illustrative purposes, and those skilled in the art can understand that it can be easily modified into other specific forms without changing the technical spirit or essential features of the present invention. Therefore, the embodiments described above should be understood as illustrative in all respects and not limiting. For example, each component described as a single type may be implemented in a distributed manner, and similarly, components described as distributed may be implemented in a combined form.

The scope of the present invention is indicated by the following claims, and all changes or modifications derived from the meaning and scope of the claims and equivalent concepts should be interpreted as being comprised in the scope of the present invention.

While the present invention has been described with respect to the specific embodiments, it will be apparent to those skilled in the art that various changes and modifications may be made without departing from the spirit and scope of the invention as defined in the following claims.

What is claimed is:

1. A lithium metal oxide nanoparticle having a shape of a hexahedron with a square outer cross section or a hexahedron with at least one chamfered corner, and
comprising a hollow of which a cross section is a square or a square having at least one chamfered corner.

2. The lithium metal oxide nanoparticle according to claim 1,
wherein a ratio (a/b) of the length (a) of a side of the outer cross section of the lithium metal oxide nanoparticle to a length (b) of one side of a square cross section of the hollow is 1.2 to 10.

3. The lithium metal oxide nanoparticle according to claim 1,
wherein a thickness of the lithium metal oxide on the hollow is 5 to 200 nm.

4. The lithium metal oxide nanoparticle according to claim 1,
wherein a BET surface area of the lithium metal oxide nanoparticle may be 20 to 200 m²/g.

5. The lithium metal oxide nanoparticle according to claim 1,
wherein an outer diameter or a length of the longest side of the lithium metal oxide nanoparticle is 15 to 1,000 nm.

6. The lithium metal oxide nanoparticle according to claim 1,
wherein the lithium metal oxide nanoparticle is made from lithium titanium oxide (LTO).

7. The lithium metal oxide nanoparticle according to claim 1,
wherein the lithium metal oxide nanoparticle is derived from lithium metal oxide that is synthesized from a calcium-containing intermediate having a shape of a hexahedron with a square outer cross section or a hexahedron with at least one chamfered corner and comprises a hollow while the shape of the hexahedron or the hexahedron with at least one chamfered corner is maintained.

8. A method for preparing lithium metal oxide nanoparticles comprising:
preparing a titanium-containing intermediate having a shape of a hexahedron with a square outer cross section or a hexahedron with at least one chamfered corner;
preparing a titanium oxide comprising a hollow by using the titanium-containing intermediate;
mixing the titanium oxide with a lithium source in a solvent to obtain a dispersed composition;
performing a heat treatment on the composition; and
washing, drying, and calcining a reactant obtained after the heat treatment.

9. The method for preparing lithium metal oxide nanoparticles according to claim 8,
wherein the heat treatment on the composition is performed for 5 to 20 hours at a temperature of 150° C. to 200° C.

10. The method for preparing lithium metal oxide nanoparticles according to claim 8,
wherein the calcining is performed for 60 to 180 minutes at a temperature of 800° C. to 1,000° C.

11. The method for preparing lithium metal oxide nanoparticles according to claim 8,
wherein in the mixing, a molar ratio (B/A) of the titanium oxide (A) and the lithium source (B) is 9 to 11.

12. The method for preparing lithium metal oxide nanoparticles according to claim 8,
wherein the preparing of the titanium-containing intermediate comprises:
mixing a calcium source, polyalkylene glycol, and a titanium source in a solvent to prepare a second dispersed composition; and
performing a heat treatment on the second dispersed composition.

13. The method for preparing lithium metal oxide nanoparticles according to claim 12,
wherein, in the mixing, a molar ratio (D/C) of the calcium source (C) and the titanium source (D) is 1 to 3.

14. The method for preparing lithium metal oxide nanoparticles according to claim 8,
wherein the preparing of the titanium oxide comprising the hollow by using the titanium-containing intermediate comprises:
mixing the titanium-containing intermediate and a chelating agent in a solvent to prepare a third dispersed composition;
performing a heat treatment on the third dispersed composition;
washing a resultant obtained after the heat treatment with a solvent and drying; and
calcining the dried resultant to obtain a titanium oxide.

15. The method for preparing lithium metal oxide nanoparticles according to claim 14,
wherein, in the mixing, a molar ratio (F/E) of the titanium-containing intermediate (E) and the chelating agent (F) is 1 to 3.

16. The method for preparing lithium metal oxide nanoparticles according to claim 14,
wherein the chelating agent is one selected from the group consisting of ethylenediaminetetraacetic acid-disodium (EDTA-2Na), EDTA-3Na, EDTA-4Na, and EDTA-4H.

17. The method for preparing lithium metal oxide nanoparticles according to claim 14,
wherein the heat treatment on the third dispersed composition is performed for 5 to 20 hours at a temperature of 150° C. to 200° C.

18. The method for preparing lithium metal oxide nanoparticles according to claim 14,
wherein the calcining of the dried resultant to obtain a titanium oxide is performed for 60 to 180 minutes at 300° C. to 500° C.

19. An electrode for an electronic device comprising:
the lithium metal oxide nanoparticle according to claim 1.
